(19) United States
(12) Patent Application Publication
(10) Pub. No.: US 2012/0133965 A1
(43) Pub. Date: May 31, 2012

(54) INFORMATION PROCESSING APPARATUS, IMAGE PROCESSING APPARATUS, METHOD FOR CONTROLLING INFORMATION PROCESSING APPARATUS, METHOD FOR CONTROLLING IMAGE PROCESSING APPARATUS, AND STORAGE MEDIUM STORING PROGRAM THEREFOR

(75) Inventor: Takashi Osuki, Kawasaki-shi (JP)

(73) Assignee: CANON KABUSHIKI KAISHA, Tokyo (JP)

(21) Appl. No.: 13/291,949

(22) Filed: Nov. 8, 2011

(30) Foreign Application Priority Data
Nov. 29, 2010 (JP) 2010-265746

(51) Int. Cl. G06K 15/02

(52) U.S. Cl. 358/1.13

(57) ABSTRACT

An information processing apparatus, to communicate with an image processing apparatus, may include a first receiving unit and a first, second, and third transmitting unit. The first receiving unit receives input information based on input to a screen displayed on a web browser included in the image processing apparatus. The first transmitting unit transmits an execution instruction a function to the image processing apparatus based on the received input information. The second transmitting unit transmits to the image processing apparatus designation information for designating which of two screens is to be used as a screen to be displayed during execution of the function. In response to a screen generated by the information processing apparatus being designated, the third transmitting unit transmits screen information for displaying the screen on the web browser included in the image processing apparatus.

### BACKGROUND OF THE INVENTION

1. Field of the Invention

The present invention relates to an information processing apparatus capable of communicating with an image processing apparatus, an image processing apparatus having a web browser, a method for controlling the information processing apparatus, a method for controlling the image processing apparatus, and a storage medium storing a program therefor.

2. Description of the Related Art

An information processing apparatus such as a personal computer (PC) is known to be connected with a web server on a network, and to display on a web browser included therein an operation screen provided by the web server.

In this case, the web browser on the information processing apparatus requests the web server for an operation screen. In response to the request from the information processing apparatus, a web application on the web server transmits to the information processing apparatus a Hyper Text Markup Language (HTML) file for displaying the operation screen on the web browser. The web browser on the information processing apparatus analyzes the received HTML file and then displays the operation screen based on the descriptions in the HTML file.

When a user inputs an instruction via the operation screen displayed on the web browser, the web browser notifies the web server of the input instruction. Upon reception of the instruction, the web application on the web server performs relevant processing according to the instruction.

In recent years, some multifunction peripherals (MFPs) provided with a scanner or a printer have been provided with the above-mentioned web browser. Such an MFP displays on the web browser included therein an operation screen provided from the web server with the above-mentioned procedures, and receives various instructions from a user.

Japanese Patent Application Laid-Open No. 2007-042098 discusses a technique in which a web server provides an operation screen for inputting an instruction for using each of scanning and printing functions included in an MFP. Specifically, a user of the MFP inputs an instruction to the MFP via the operation screen displayed on the web browser. Then, the web browser of the MFP transfers the user-input instruction to the web server.

Upon reception of the instruction, the web server transfers an instruction for executing a function corresponding to the user-input instruction (hereinafter the instruction is also referred to as a function-execution instruction). Upon reception of the function-execution instruction from the web server, the MFP executes the designated function. The use of this technique eliminates the need of storing in the MFP the entire menu data for operating the MFP, making it easier to change menu data on the web server.

The MFP employing the above-mentioned technique uses a screen generated by loading a program stored therein as a screen to be displayed on a display unit during function execution according to the function-execution instruction received from the web server. This technique eliminates the need of generating on the web server side a screen to be displayed during function execution by the MFP, thus reducing the load on the web server.

In this case, however, although the web server provides an operation screen for inputting an instruction for using each function of the MFP, the MFP cannot use a screen generated by the web server as a screen to be displayed during function execution. Some web applications on the web server provide not only an operation screen for inputting an instruction for using a function but also a screen displayed during function execution by the MFP, possibly improving user operability. Even in this case, however, a screen generated by the web server cannot be used as a screen to be displayed during function execution by the MFP.

### SUMMARY OF THE INVENTION

The present invention is directed to an image processing apparatus capable of improving user operability in a technique with which a web server provides an operation screen thereof.

According to an aspect of the present invention, an information processing apparatus to communicate with an image processing apparatus includes a first receiving unit configured to receive input information based on a user input to a screen displayed on a web browser included in the image processing apparatus, a first transmitting unit configured to transmit an execution instruction for executing a function to the image processing apparatus based on the received input information, a second transmitting unit configured to transmit to the image processing apparatus designation information for designating which of a screen based on screen information generated by the information processing apparatus and a screen generated by the image processing apparatus is to be used as a screen to be displayed during execution of the function by the image processing apparatus according to the execution instruction, and a third transmitting unit configured to, in response to the screen generated by the information processing apparatus being designated to be used as the screen to be displayed on a display unit of the image processing apparatus during execution of the function by the image processing apparatus, transmit screen information for displaying the screen on the web browser included in the image processing apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of an information processing system according to an exemplary embodiment.

FIG. 2 is a block diagram illustrating a hardware configuration of a web server and an MFP according to the exemplary embodiment.

FIG. 3 is a block diagram illustrating a software configuration of the web server and the MFP according to the exemplary embodiment.

FIG. 4 illustrates an exemplary display screen on the web browser according to the exemplary embodiment.

FIG. 5 is a flowchart illustrating operations of the web server according to the exemplary embodiment.

FIG. 6 is a flowchart illustrating operations of the MFP according to the exemplary embodiment.

### DESCRIPTION OF THE EMBODIMENTS

Various exemplary embodiments, features, and aspects of the invention will be described in detail below with reference to the drawings.

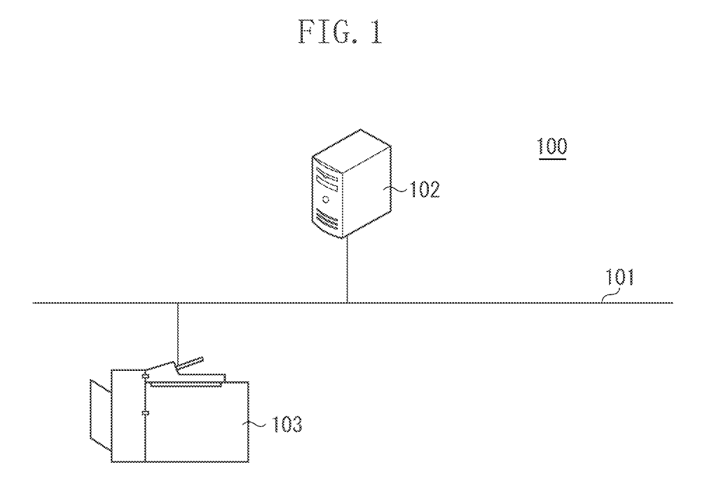

FIG. 1 illustrates an exemplary configuration of an information processing system 100 according to the present exemplary embodiment.

The information processing system 100 includes an MFP 103 having a web browser function, and a web server 102 having a web server function. A local area network (LAN) 101 connects between the web server 102 and the MFP 103. The web server 102 and the MFP 103 are capable of communicating with each other via the LAN 101.

In response to a request from a web browser 301 included in the MFP 103, the web server 102 returns graphic user interface (GUI) data as screen information. Although the GUI data is, for example, an HTML file, it may be a non-HTML file. The GUI data may include a program to be executed by the web browser, such as a script.

The web server 102 also receives from the web browser 301 input information input via a screen generated based on the GUI data. Then, the web server 102 transmits a function-execution instruction to a service application corresponding to the input information out of a plurality of service applications included in the MFP 103. Then, upon reception of a result of function execution by the service application, the web server 102 generates GUI data indicating a processing result and transmits the GUI data to the web browser 301.

The MFP 103 includes the web browser 301 and at least one service application, requests the web server 102 for GUI data, and displays on a display unit a screen generated based on the GUI data transmitted from the web server 102. The MFP 103 also transmits to the web server 102 input information input from the screen generated based on the GUI data.

In the following descriptions, a screen generated based on GUI data transmitted from the web server is referred to as a Web UI. On the other hand, the MFP 103 can also display a screen generated by loading a program stored therein. In the following descriptions, a screen generated by the MFP 103 itself is referred to as a Native UI.

The MFP 103 is an exemplary image processing apparatus, and may be other image processing apparatuses such as a printer, a scanner, a facsimile, and a copying machine. The web server 102 is implemented not only by a computer such as a PC but also by a printer and any other information processing apparatuses having the above-mentioned web server function. The LAN 101 may be a communication method such as the Internet and a radio communication system.

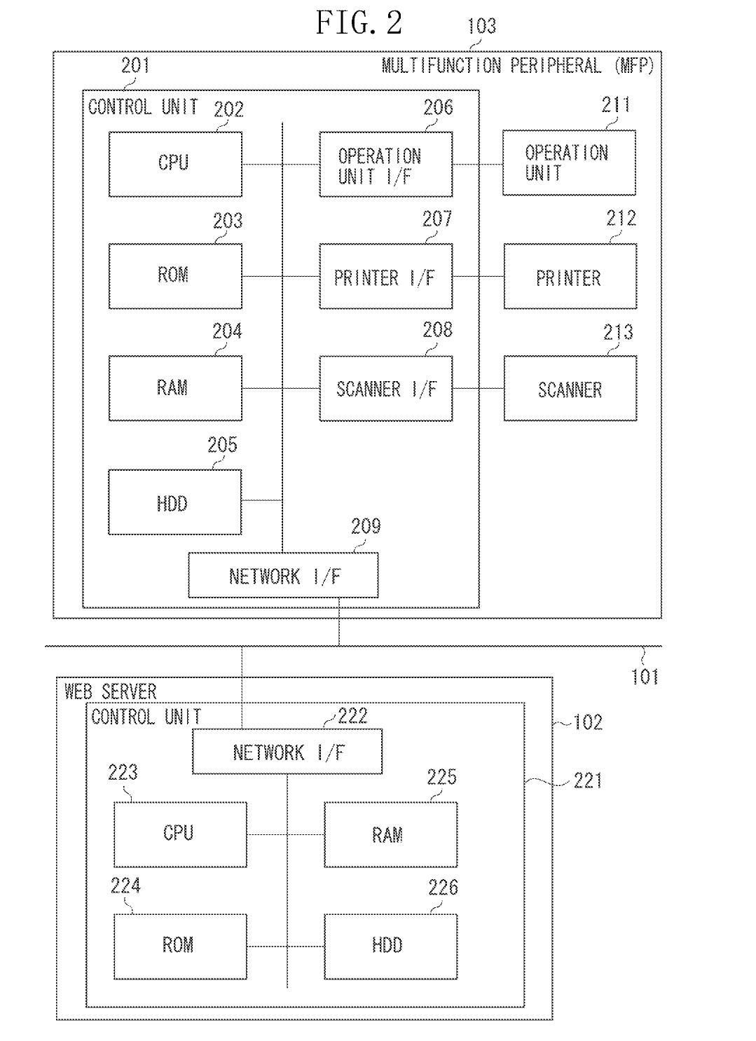

A hardware configuration of the web server 102 and the MFP 103 in the information processing system 100 according to the present exemplary embodiment will be described below with reference to FIG. 2.

Referring to FIG. 2, a control unit 201 including a central processing unit (CPU) 202 totally controls the MFP 103. The CPU 202 loads control programs stored in a read-only memory (ROM) 203 or a hard disk drive (HDD) 205 into a random access memory (RAM) 204, and executes various pieces of control processing. The RAM 204 is used as a main memory or a temporary storage area such as a work area by the CPU 202. The HDD 205 stores image data, various programs, and various information tables. An operation unit interface (I/F) 206 connects an operation unit 211 to the control unit 201.

The operation unit 211 is provided with a display unit (a liquid crystal display unit having a touch-panel function) or a keyboard. A printer I/F 207 connects a printer 212 to the control unit 201. Image data to be printed by the printer 212 is transmitted from the control unit 201 to the printer 212 via the printer I/F 207, and then printed on a recording medium by the printer 212.

A scanner I/F 208 connects a scanner 213 to the control unit 201. The scanner 213 scans an image on a document, generates relevant image data, and transfers the generated image data to the control unit 210 via the scanner I/F 208. A network I/F 209 is a control unit for transmitting and receiving various pieces of information to/from the web server 102 on the LAN 101. When the power of the MFP 103 having the above-mentioned configuration is turned ON, the CPU 202 initializes the MFP 103 according to a boot program in the ROM 203, loads an operating system (OS) stored in the HDD 205 and such, and then executes various applications.

The hardware configuration of the web server 102 will be described below. The control unit 221 including a CPU 223 totally controls the web server 102. The CPU 223 loads control programs stored in a ROM 224 or an HDD 226 into a RAM 225, and then executes various pieces of control processing. The RAM 225 is used as a main memory or a temporary storage area such as a work area by the CPU 223. The HDD 226 stores image data, various programs, and various information tables. A network I/F 222 is a control unit for transmitting and receiving various pieces of information to/from the MFP 103 on the LAN 101.

When the power of the web server 102 having the above-mentioned configuration is turned ON, the CPU 223 initializes the web server 102 according to a boot program in the ROM 224, loads an OS stored in the HDD 226 and such, and then executes various applications.

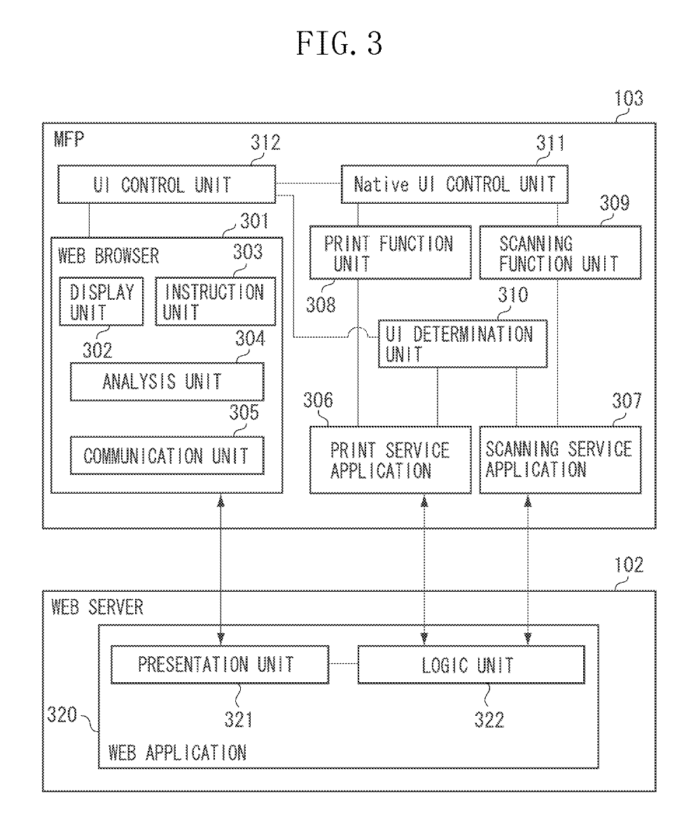

FIG. 3 illustrates a software functional configuration of the web server 102 and the MFP 103 in the information processing system 100 according to the present exemplary embodiment.

In the MFP 103, the software functions illustrated in FIG. 3 are implemented when the CPU 202 loads a relevant program stored in the ROM 203 or the HDD 205 and then executes it. In the web server 102, the software functions are implemented when the CPU 223 loads a relevant program stored in the ROM 224 or the HDD 226 and then executes it.

In the MFP 103, various pieces of information used during execution of the software functions are stored in the RAM 204 or the HDD 205, and transferred between the software functions. Likewise, in the web server 102, various pieces of information used during execution of the software functions are stored in the RAM 225 or the HDD 226, and transferred between the software functions. The MFP 103 uses the network I/F 209, and the web server 102 uses the network I/F 222 to communicate with an external device.

Each software function will be described below. The MFP 103 includes the web browser 301, a print service application 306, a scanning service application 307, a print function unit 308, a scanning function unit 309, a UI determination unit 310, a Native UI control unit 311, and a UI control unit 312.

The web browser 301 includes a display unit 302, an instruction unit 303, an analysis unit 304, and a communication unit 305. The communication unit 305 communicates with a presentation unit 321 of a web application 320 based on an HTTP protocol. Specifically, the communication unit 305 transmits an instruction from the instruction unit 303 to the web application 320, receives GUI data from the presentation unit 321 as a response, and then transfers the received GUI data to the analysis unit 304.

The analysis unit 304 analyzes the GUI data received by the communication unit 305, generates display data for screen display, and then transfers the generated display data to the display unit 302. The analysis unit 304 also analyzes the instruction from the instruction unit 303 and then transfers data conforming to the HTTP protocol to the communication unit 305. The display unit 302 displays a screen based on the display data received from the analysis unit 304.

When a user inputs an instruction via the screen displayed on the display unit 302, the instruction unit 303 receives input information indicating the contents of the instruction via the UI control unit 312, and transfers the input information to the analysis unit 304.

As mentioned above, the web browser 301 serves as a software function of transmitting and receiving to/from the web application 320 screen information and input information based on a screen operation on the MFP 103.

Then, the print service application 306 operates the print function unit 308 of the MFP 103 based on an instruction from outside. Specifically, the web application 320 receives input information from the web browser 301. Then, a logic unit 322 uses the print function unit 308 of the MFP 103 via the print service application 306. The print service application 306 notifies the web server 102 which is a source of the request of a processing status of a print function requested by the web application 320.

Although the scanning service application 307 basically performs similar processing to the print service application 306, the difference appears in the fact that the target to be operated is not the print function unit 308 but the scanning function unit 309. The print service application 306 and the scanning service application 307 are exemplary service applications included in the MFP 103. The MFP 103 may be provided with other service applications.

The print function unit 308 is a software function of controlling the printer function 212 via the printer I/F 207. Likewise, the scanning function unit 309 is a software function of controlling the scanner function 213 via the scanner I/F 208.

The Native UI control unit 311 generates display data and transfers the display data to the UI control unit 312 depending on the statuses of the print function unit 308, the scanning function unit 309, and the MFP 103. The Native UI control unit 311 also receives via the UI control unit 312 input information input from the operation unit 211 by the user, and transfers the input information to the print function unit 308 or the scanning function unit 309.

The UI determination unit 310 analyzes designation information from the web application 320 received by the print service application 306 or the scanning service application 307. Then, based on a result of the analysis, the UI determination unit 310 determines which of Web UI and Native UI is to be used as a screen to be displayed on the display unit of the operation unit 211 during function execution by the MFP 103.

Based on a result of the determination by the UI determination unit 310, the UI control unit 312 receives display data from the Native UI control unit 311 or the web browser 301 and then displays the display data on the operation unit 211. Moreover, based on a result of the determination by the UI determination unit 310, the UI control unit 312 notifies the Native UI control unit 311 or the web browser 301 of the input information from the operation unit 211.

Software functions of the web server 102 will be described below. The web server 102 is provided with the web application 320. The web application 320 includes the presentation unit 321 and the logic unit 322.

The presentation unit 321 communicates with the communication unit 305 and, in response to a request from the web browser 301, transmits GUI data to be displayed on the web browser 301 to the communication unit 305. The presentation unit 321 also receives input information indicating the contents of a user input to a screen displayed on the display unit 302 of the web browser 301. When the received input information is an instruction for executing a function (for example, a print function and a scanning function) of the MFP 103, the presentation unit 321 transfers the input information to the logic unit 322.

The logic unit 322 receives from the presentation unit 321 the instruction for executing a function included in the MFP 103. Then, according to the received function-execution instruction, the logic unit 322 instructs various service applications such as the print service application 306 and the scanning service application 307 in the target MFP 103.

In the present exemplary embodiment, the logic unit 322 transmits two different pieces of information to various service applications of the MFP 103. One piece of information is the above-mentioned function-execution instruction, and the other piece of information is designation information for designating which of Web UI and Native UI is to be used as a screen to be displayed on the display unit on the operation unit 211 during function execution by the MFP 103.

The logic unit 322 may separately or collectively transmit these pieces of information to the MFP 103. As an exemplary transmission method, tags are inserted into XML data when communication between the web server 102 and the service applications of the MFP 103 is based on a web service protocol (for example, Simple Object Access Protocol (SOAP)). However, the transmission method is not limited thereto but may be any other methods as long as the above-mentioned pieces of information can be transmitted to service applications.

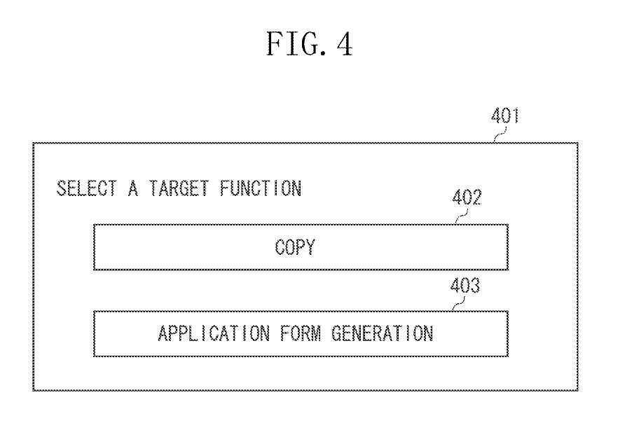

FIG. 4 illustrates an exemplary screen displayed on the display unit 302 of the web browser 301 on the MFP 103, i.e., a menu screen used by the user to select a function to be executed by the MFP 103. This screen is generated based on GUI data generated by the presentation unit 321 of the web server 102 in response to a request from the web browser 301.

Referring to FIG. 4, a screen 401, illustrating the entire screen displayed on the display unit 302, includes menus 402 and 403.

A menu item 402 is an exemplary menu for executing a copy function with the combination of the scanning service application 307 and the print service application 306. A menu item 403 is an exemplary menu for executing an application form generation function of generating an application from a scanned image with the combination of the scanning service application 307 and the print service application 306.

In the present exemplary embodiment, the copy function (menu item 402) uses Native UI as a screen to be displayed on the MFP 103 during execution of the scanning service application 307, and the application form generation function (menu item 403) uses Web UI as a screen to be displayed on the MFP 103 during execution of the scanning service application 307.

When the user selects the menu item 402 or the menu item 403 on the screen illustrated in FIG. 4 (when the user touches a relevant portion on a touch panel), input information indicating the contents of the selection is transmitted to the web application 320 of the web server 102. The presentation unit 321 of the web application 320 receives the input information, generates GUI data corresponding to the input information, and transmits the generated GUI data to the web browser 301 of the MFP 103. The web browser 301 displays a following screen generated based on the received GUI data.

For example, when the user selects the menu item 402 on the screen illustrated in FIG. 4, the MFP 103 transmits to the web server 102 input information indicating the selection of the copy function. Then, the web server 102 transmits to the web browser 301 GUI data for a following screen to be displayed (for example, a copy setting screen).

When the user selects the menu item 403 on the screen in FIG. 4, the MFP 103 transmits to the web server 102 input information indicating the selection of the application form generation function. Then, the web server 102 transmits to the web browser 301 GUI data for a following screen to be displayed (for example, a detail setting screen for application form generation).

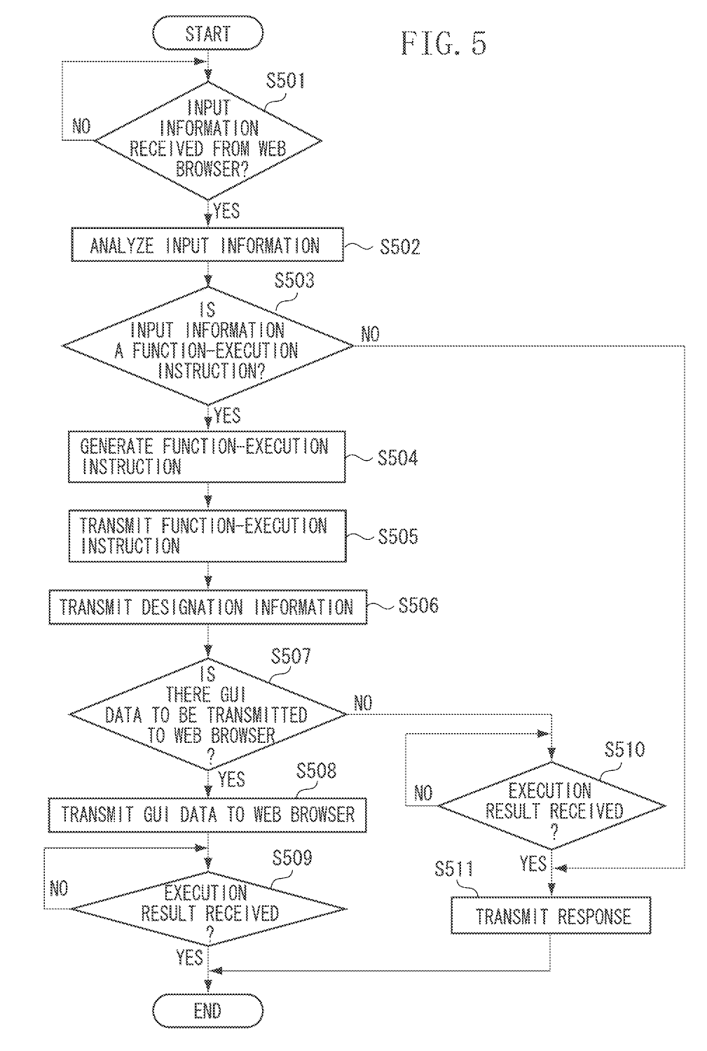

FIG. 5 is a flowchart illustrating operations of the web server 102. The operations of the web server 102 according to the present exemplary embodiment will be described below with reference to FIG. 5.

Each step of the flowchart is implemented when the CPU 223 included in the web server 102 loads a relevant program stored in the ROM 224 or the HDD 226 into the RAM 225 and then executes it.

In step S501, the CPU 223 determines whether input information is received from the web browser 301 of the MFP 103. The web browser 301 transmits the input information based on an input to a screen displayed on the web browser 301, or an input to the operation unit 211 of the MFP 103. The web application 320 waits for reception of the input information. When the CPU 223 determines that the input information is received (YES in step S501), the processing proceeds to step S502.

In step S502, the CPU 223 analyzes the received input information. In step S503, the CPU 223 determines whether the received input information is an instruction for executing a function of the MFP 103. When the CPU 223 determines that the received input information is an instruction for executing a function of the MFP 103 (YES in step S503), the processing proceeds to step S504. On the other hand, when it determines that the received input information is not an instruction for executing a function thereof (NO in step S503), the processing proceeds to step S511. The received input information is not a function-execution instruction, for example, when it is a GUI data request.

In step S504, based on a result of the analysis in step S502, the CPU 223 generates a function-execution instruction to be transmitted to the service application of the MFP 103. Specifically, the CPU 223 analyzes, in step S502, which function of the MFP 103 is instructed to be executed by the function-execution instruction (the received input information) and, based on a result of the analysis, generates a function-execution instruction to the service application corresponding to the function. The generated function-execution instruction may include various setting values regarding the function to be executed.

In step S505, the CPU 223 transmits the generated function-execution instruction to the service application corresponding to the function to be executed. For example, when the web server 102 receives input information for executing the copy function indicated by the menu item 402 illustrated in FIG. 4, the CPU 223 generates a function-execution instruction for instructing the scanning service application 307 of the MFP 103 to execute the scanning function unit 309. The generated function-execution instruction includes various setting values regarding the scanning function, such as the resolution and scanning size. The CPU 223 transmits the function-execution instruction to the scanning service application 307 of the MFP 103.

In step S506, the CPU 223 transmits designation information for designating which of Web UI and Native UI is to be used as a screen to be displayed on the display unit of the operation unit 211 of the MFP 103 during execution of the function, by the MFP 103, designated by the function-execution instruction transmitted in step S505. The destination of the designation information is the same as the destination of the function-execution instruction transmitted in step S505.

Steps S505 and S506 may be collectively performed as one step, not as separate steps. Specifically, it is also possible to transmit information including the function-execution instruction in step S505 and the designation information in step S506 to a relevant service application of the MFP 103. The UI determination unit 310 can determine which of Native UI and Web UI is to be used as a screen to be displayed on the display unit of the operation unit 211 of the MFP 103 during function execution by the MFP 103 for each application provided by the web application 320.

In the present exemplary embodiment, for example, the copy function (copy application) in FIG. 4 uses Native UI and the application form generation function (application form generation application) uses Web UI. The above-mentioned determinations can be arbitrarily made by developers who develop applications provided by the web server.

In step S507, the CPU 223 determines whether there is GUI data to be transmitted to the web browser 301. When the use of Web UI is designated instep S506, the CPU 223 determines that there is GUI data to be transmitted to the web browser 301 (YES in step S507), and the processing proceeds to step S508. On the other hand, when the use of Native UI is designated in step S506, the CPU 223 determines that there is no GUI data to be transmitted to the web browser 301 (NO in step S507), and the processing proceeds to step S510.

In step S508, the CPU 223 transmits the GUI data to the web browser 301 as a response to the input information received from the web browser 301 in step S501. The GUI data transmitted in step S508 is to be used as a screen to be displayed on the display unit 302 of the web browser 301 during function execution by the MFP 103.

Web application developers can freely customize the screen to be displayed during function execution by freely generating GUI data, thus providing users with a more comprehensible screen. There are cases where a plurality of screens needs to be displayed on the web browser 301 and where screen display needs to be changed according to the progress of processing by the MFP 103. For these cases, the web server 102 may transmit to the web browser 301, together with the GUI data transmitted thereto in step S508, an instruction to make the web browser 301 acquire a screen from the web server 102 at regular intervals or a certain timing. Alternatively, the web server 102 may transmit GUI data generated thereby to the web browser 301 at a desired timing.

In step S509, the CPU 223 determines whether a result of the function execution is received from the service application to which the function-execution instruction was transmitted in step S505. The CPU 223 waits for reception of the result of the function execution and, when it determines that the result of the function execution is received (YES in step S509), the processing ends. The result of the function execution received in step S509 may be not only the end of processing but also an error notification.

When the use of Native UI is designated in step S506, the CPU 223 determines that there is no GUI data to be transmitted to the web browser 301 (NO in step S507), and the processing proceeds to step s510.

In step s510, the CPU 223 determines whether a result of the function execution is received from the service application to which the function-execution instruction was transmitted in step S505. The CPU 223 waits for reception of the result of the function execution and, when it determines that the result of the function execution is received (YES in step S510), the processing proceeds to step S511.

In step S511, the CPU 223 generates GUI data corresponding to the received result of the function execution and then transmits it to the web browser 301 as a response to the input information received from the web browser 301 in step S501.

The result of the function execution received in step S510 may be not only the end of processing but also an error notification. In step S511, when a result of the function execution indicating the normal end of processing is received, the CPU 223 generates GUI data corresponding to it. When a result of the function execution indicating an error is received, the CPU 223 generates GUI data indicating, for example, an error cancel screen. Then, in step S511, the CPU 223 transmits the generated GUI data to the web browser 301, and the processing ends.

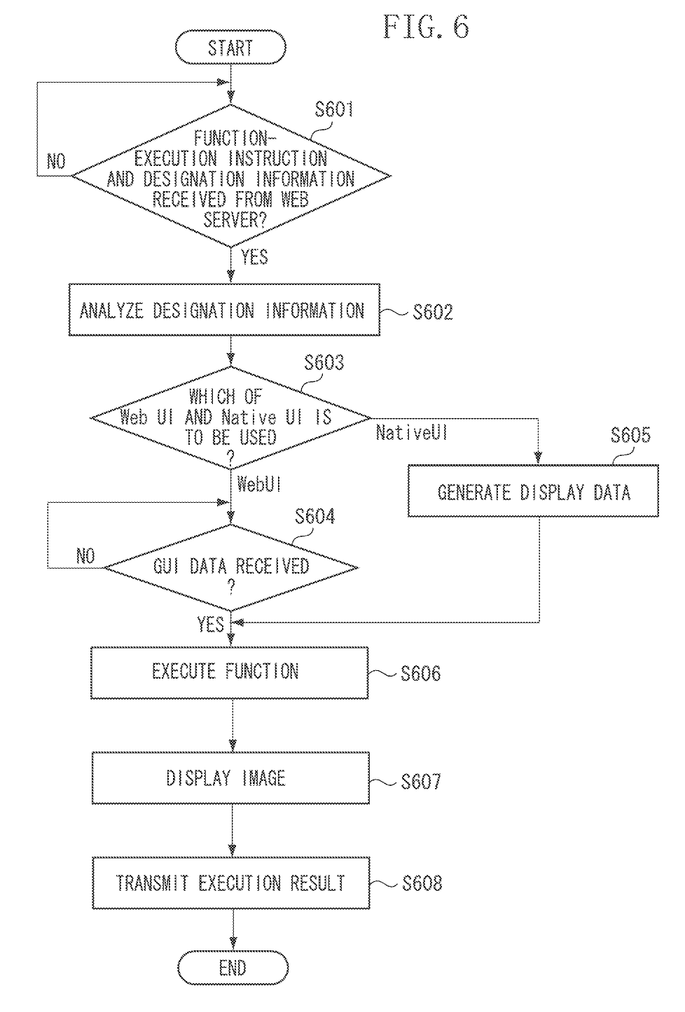

FIG. 6 is a flowchart illustrating operations of the MFP 103. The operations of the MFP 103 in the present exemplary embodiment will be described below with reference to FIG. 6.

Each step of the flowchart is implemented when the CPU 202 included in the MFP 103 loads a relevant program stored in the ROM 203 or the HDD 205 into the RAM 204 and then executes it.

The flowchart in FIG. 6 describes operations performed by the MFP 103 when the service application receives a function-execution instruction and designation information from the web server 102. Although the MFP 103 also performs operations for the above-mentioned communication between the web browser 301 and the web server 102, descriptions of these operations will be omitted.

In step S601, the CPU 202 determines whether the function-execution instruction and the designation information are received from the web server 102. Specifically, the logic unit 322 of the web server 102 determines whether the function-execution instruction and the designation information, transmitted to the service application of the MFP 103 in steps S505 and S506 in FIG. 5, respectively, are received. In step S601, the CPU 202 waits for reception of these pieces of information, and, when it determines that these pieces of information are received (YES in step S601), the processing proceeds to step S602.

In step S602, the CPU 202 analyzes the designation information received in step S601, and then the processing proceeds to step S603. In step S603, the CPU 202 determines which of Web UI and Native UI is designated by the designation information. Specifically, the CPU 202 determines which of Web UI and Native UI is to be used as a screen to be displayed on the display unit of the operation unit 211 of the MFP 103 during execution of the function designated by the function-execution instruction received in step S601.

When the CPU 202 determines the use of Web UI in step S603, the processing proceeds to step S604. On the other hand, when it determines the use of Native UI in step S603, the processing proceeds to step S605.

In step S604, the CPU 202 waits for reception of GUI data transmitted from the web server 102, and, when it determines that the GUI data is received (YES in step S604), the processing proceeds to step S606. In this case, the UI control unit 312 uses a screen generated from the GUI data as a screen to be displayed during function execution.

On the other hand, when the CPU 202 determines the use of Native UI in step S603, the processing proceeds to step S605. In step S605, the CPU 202 generates a screen to be displayed during function execution. In this case, the UI control unit 312 uses a screen based on display data generated by the Native UI control unit 311 as a screen to be displayed during function execution. As mentioned above, the Native UI control unit 311 generates display data depending on the statuses of the print function unit 308, the scanning function unit 309, and the MFP 103.

In step S606, the CPU 202 executes a function based on the function-execution instruction received in step S601. For example, the scanning service application 307 operates the scanning function unit 309 based on various setting values included in the received function-execution instruction to perform the scanning function. Alternatively, the print service application 306 operates the print function unit 308 based on various setting values included in the received function-execution instruction to perform the print function.

In step S607, in conjunction with the function execution in step S606, the CPU 202 displays a screen on the display unit of the operation unit 211 during function execution. Specifically, based on the result of the determination in step S603, the UI control unit 311 displays Web UI (a screen generated based on the GUI data received from the web server 102) or Native UI (a screen generated based on the display data generated by the Native UI control unit 311) on the screen.

In step S608, the CPU 202 transmits a result of the function execution to the web server 102. If an error occurs during function execution, error information is included in the result of the function execution to be transmitted to the web server 102. When the function is normally completed, the end of function is included in the result of the function execution to be transmitted thereto.

When the result of the function execution is notified to web server 102 in step S608, the web server 102 transmits to the MFP 103 screen information for a screen to be displayed next by the MFP 103. This screen indicates a result of the function execution, for example, “end of job.”

If the MFP 103 has displayed Web UI according to the result of the determination in step S603, the MFP 103 continuously displays the function execution result screen with Web UI. On the other hand, if MFP 103 has displayed Native UI according to the result of the determination in step S603, the MFP 103 selects Web UI when displaying the function execution result screen. Specifically, the screen is returned to the web browser 301.

The screen to be transmitted to the MFP 103 by the web server 102 after the result of the function execution is notified to the web server 102 in step S608 is not limited to the function execution result screen, but may be the initial screen, for example, the menu screen.

As mentioned above, according to the present exemplary embodiment, developers who develop and provide web applications can determine for each web application which of Web UI and Native UI is to be used as a screen to be displayed on the display unit of the operation unit 211 of the MFP 103 during function execution by the MFP 103.

The use of Web UI as a screen to be displayed during function execution by the MFP 103 enables the provision of a user-friendly screen including necessary guidances instead of a Native UI-based fixed screen. On the other hand, if sufficient screen display can be made with Native UI, Native UI can be used. In this case, therefore, web application developers are freed from works of generating screen information.

Each step of the flowcharts in FIGS. 5 and 6 refers to examples of a first receiving unit, a second receiving unit, a first transmitting unit, a second transmitting unit, a third transmitting unit, a fourth transmitting unit, and a control unit. However, the embodiments of the present invention are not limited thereto. The web server 102 according to the present exemplary embodiment maybe configured with a plurality of apparatuses. In this case, each individual apparatus may perform distributed processing or hold a different web application. Further, the above-mentioned apparatuses may be arranged on the Internet instead of a LAN.

Aspects of the present invention can also be realized by a computer of a system or apparatus (or devices such as a CPU or MPU) that reads out and executes a program recorded on a memory device (computer-readable medium) to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention. In an example, a computer-readable medium may store a program that causes an information processing apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-265746 filed Nov. 29, 2010, which is hereby incorporated by reference herein in its entirety.

What is claimed is:

1. An information processing apparatus capable of communicating with an image processing apparatus, the information processing apparatus comprising:
a first receiving unit configured to receive input information based on a user input to a screen displayed on a web browser included in the image processing apparatus;
a first transmitting unit configured to transmit an execution instruction for executing a function to the image processing apparatus based on the received input information;
a second transmitting unit configured to transmit to the image processing apparatus designation information for designating which of a screen based on screen information generated by the information processing apparatus and a screen generated by the image processing apparatus is to be used as a screen to be displayed during execution of the function by the image processing apparatus according to the execution instruction; and
a third transmitting unit configured to, in response to the screen generated by the information processing apparatus being designated to be used as the screen to be displayed on a display unit of the image processing apparatus during execution of the function by the image processing apparatus, transmit screen information for displaying the screen on the web browser included in the image processing apparatus.

2. The information processing apparatus according to claim 1, wherein the first and second transmitting units transmit the execution instruction or the designation information to a service application designated by the input information out of service applications included in the image processing apparatus, and the third transmitting unit transmits the screen information to the web browser included in the image processing apparatus.

3. The information processing apparatus according to claim 1, wherein the third transmitting unit transmits the screen information as a response to the input information received by the first receiving unit.

4. The information processing apparatus according to claim 1, further comprising:
a second receiving unit configured to receive from the image processing apparatus a result of execution of the function according to the function-execution instruction; and
a fourth transmitting unit configured to transmit screen information for displaying on the web browser included in the image processing apparatus a screen corresponding to the result of execution of the function received by the second receiving unit.

5. The information processing apparatus according to claim 1, wherein the function executed by the image processing apparatus according to the function-execution instruction transmitted by the first transmitting unit is a scanning function or a print function.

6. The information processing apparatus according to claim 1, wherein the screen information transmitted by the third transmitting unit is a Hyper Text Markup Language (HTML) file.

7. An image processing apparatus having a web browser, the image processing apparatus comprising:
a transmitting unit configured to transmit to an information processing apparatus input information based on a user input to a screen displayed on the web browser;
a first receiving unit configured to receive an execution instruction for executing a function transmitted from the information processing apparatus based on the input information;
an execution unit configured to execute the function according to the execution instruction;
a second receiving unit configured to receive from the information processing apparatus designation information for designating which of a screen based on screen information generated by the information processing apparatus and a screen generated by the image processing apparatus is to be used as a screen to be displayed by the image processing apparatus during execution of the function by the execution unit; and
a control unit configured to, in response to the screen based on the screen information generated by the information processing apparatus being designated to be used, display on the web browser the screen generated based on the screen information transmitted from the information processing apparatus, and, in response to the screen generated by the image processing apparatus being designated to be used, display the screen generated by the image processing apparatus.

8. A method for controlling an information processing apparatus capable of communicating with an image processing apparatus, the method comprising:
receiving input information based on a user input to a screen displayed on a web browser included in the image processing apparatus;
transmitting an execution instruction for executing a function to the image processing apparatus based on the received input information;
transmitting to the image processing apparatus designation information for designating which of a screen based on screen information generated by the information processing apparatus and a screen generated by the image processing apparatus is to be used as a screen to be displayed during execution of the function by the image processing apparatus according to the execution instruction; and
transmitting, in response to the screen generated by the information processing apparatus being designated to be used as the screen to be displayed on a display unit of the image processing apparatus during execution of the function by the image processing apparatus, screen information for displaying the screen on the web browser included in the image processing apparatus.

9. A method for controlling an image processing apparatus having a web browser, the method comprising:
transmitting to an information processing apparatus input information based on a user input to a screen displayed on the web browser;
receiving an execution instruction for executing a function transmitted from the information processing apparatus based on the input information;
executing the function according to the execution instruction;
receiving from the information processing apparatus designation information for designating which of a screen based on screen information generated by the information processing apparatus and a screen generated by the image processing apparatus is to be used as a screen to be displayed by the image processing apparatus during execution of the function; and
controlling to, in response to the screen based on the screen information generated by the information processing apparatus being designated to be used, display on the web browser the screen generated based on the screen information transmitted from the information processing apparatus, and, in response to the screen generated by the image processing apparatus being designated to be used, display the screen generated by the image processing apparatus.

10. A non transitory computer-readable storage medium storing a computer program for causing a computer to execute the method according to claim 8.

11. A non transitory computer-readable storage medium storing a computer program for causing a computer to execute the method according to claim 9.
